(19) United States
(12) Patent Application Publication
(10) Pub. No.: US 2025/0188330 A1
(43) Pub. Date: Jun. 12, 2025

(54) CROSS-LINKABLE SILYL-TERMINATED POLYMER COMPOSITION AND METHOD FOR JOINING SUBSTRATES IMPLEMENTING SAID COMPOSITION

(71) Applicant: Bostik SA, COLOMBES (FR)

(72) Inventors: Foudil MAMERI, Venette (FR); Lahoussaine LALOUCH, Venette (FR); Jean-Marie Bordat, Venette (FR)

(21) Appl. No.: 18/575,027

(22) PCT Filed: Jul. 6, 2022
(86) PCT No.: PCT/FR2022/051354

§ 371 Date: Dec. 28, 2023

(30) Foreign Application Priority Data
Jul. 8, 2021 (FR) FR2107429

(51) Int. Cl. C09J 183/06; C09J 11/04; C09J 11/08

(52) U.S. Cl. CPC C09J 183/06; C09J 11/04; C09J 11/08

(57) ABSTRACT

1) A crosslinkable adhesive composition comprising:
at least one polymer (A) comprising a hydrolyzable alkoxysilane group;
at least one tackifying resin (B);
at least one pyrogenic silica (C), preferably hydrophobic;
at least one crosslinking catalyst (D); and
a silsesquioxane resin (E).
2) Use of said composition for the semi-structural joining of two substrates.
3) A process for assembling two substrates, comprising:
melting said composition by heating to a temperature from 30 to 130° C., then
depositing said composition on a surface of a first substrate, then
crosslinking said composition by heating at a temperature from 15 to 200° C. and bringing said surface into contact with a surface of a second substrate.

### FIELD OF THE INVENTION

The present invention relates to a novel crosslinkable adhesive composition based on a polymer comprising at least one hydrolyzable alkoxysilane group. It also relates to the use thereof as a semi-structural adhesive for assembling two substrates. Finally, it relates to a process for assembling two substrates by adhesive bonding, which comprises depositing said composition, particularly in the form of a bead, on a surface of one of the two substrates to be assembled.

### TECHNICAL BACKGROUND

Adhesives are used in numerous industrial fields for the semi-structural assembly of a wide variety of substrates. Semi-structural assembly means an assembly of two substrates in which the adhesive seal is able to withstand shear stresses within a range extending from 2 to 8 MPa.

For example, in automotive construction, adhesives play an important role in the manufacture and assembly of various items of equipment intended for cars, and also in the attachment of said items of equipment or various elements to the chassis, with a view to finishing the bodywork in order to form the passenger compartment. This may thus relate to the interior trim of the doors, the roof, the floor, the trunk or else to the assembly of seats or windshields. Other elements like filters, such as the air filter, are also attached by means of adhesives, close to the engine.

Thus, all manner of substrates can be assembled together by means of semi-structural adhesives, and/or can be attached to the metal chassis of cars in automated production lines.

Hot-melt adhesives are commonly used for this type of application.

Hot-melt adhesives are adhesives which do not contain solvent, which are solid or highly viscous at ambient temperature, and which are applied in the molten state at a temperature ranging from 150° C. to 210° C. to the substrate to be attached and/or assembled. After cooling, the adhesive returns to the solid state and thus forms, following a physical process, a cohesive adhesive seal which securely attaches the two substrates to be assembled. Said adhesive seal can thus withstand shear stresses in a range extending from 2 to 8 MPa, approximately. Hot-melt adhesives are generally in the form of compositions which comprise a thermoplastic polymer and optionally a tackifying resin and a plasticizer.

With a view to forming an assembly, the hot-melt adhesives are often deposited in the form of a bead on a surface of a first substrate. Such a bead is obtained by hot extrusion of the adhesive through a connected die or else from a cartridge held by an operator, or else from a reservoir (in the case of robotic application on an assembly line). The bead can thus be precisely positioned on the surface of the first substrate, at the desired location for assembly with a surface of a second substrate. The diameter of the bead can also be adjusted within a range extending for example from 2 mm to 2 cm, on the basis of the amount desired for the coating, with a view to forming the adhesive seal.

However, the disadvantage of hot-melt adhesives is that, precisely because of the presence of a thermoplastic polymer in the adhesive seal, said seal has, in the final assembly and the article containing this final assembly, heat resistance which may prove insufficient over the lifetime of the assembly depending on the temperature and stress conditions to which said assembly is exposed. Another disadvantage of hot-melt adhesives is also their very high application temperature, as defined above.

This is why reactive (or crosslinkable) hot-melt adhesives have been developed and are commonly implemented in various fields of industry, including the field of semi-structural assembly and/or the field of automotive construction.

Crosslinkable hot-melt adhesives are also solid or highly viscous at ambient temperature, and are applied hot to a substrate. After cooling, such an adhesive thus returns to its solid form, thereby giving the adhesive seal an initial cohesion, which is often referred to in the art as “green strength”. In addition, the cohesion of said seal is considerably strengthened under the effect of a chemical crosslinking reaction which takes place in the presence of the humidity present in the ambient air and/or on the surface of the substrates to be assembled. Before crosslinking, the composition constituting the adhesive seal remains thermoplastic and can be re-melted and re-solidified. After crosslinking, the chains of the polymer contained in the adhesive composition are connected to one another by chemical bonding to form a three-dimensional network, as a result of which the adhesive seal is not longer thermoplastic, but rather is in an irreversible solid form.

Such a crosslinked adhesive composition thus gives the adhesive seal final cohesion and heat resistance which are greatly improved with respect to a non-reactive hot-melt adhesive.

Reactive hot-melt adhesives are generally polyurethane hot-melt adhesives that crosslink using humidity, also referred to as HMPUR (hot melt polyurethane). The reactive portion of the corresponding composition consists of an isocyanate-terminated polyurethane prepolymer which reacts with humidity, such that the polymer chains are connected by urea bonds to form a three-dimensional network. Isocyanate-terminated polyurethane prepolymers are conventionally prepared by reacting diols with an excess of diisocyanates. These HMPURs can be readily implemented in the form of beads, and have the advantages of a fast crosslinking rate, excellent mechanical properties for the adhesive seal after crosslinking, and adhesion to a wide variety of substrates.

However, these HMPURs have a disadvantage associated with the presence, in the adhesive composition, of significant residual amounts of diisocyanates which are more volatile and are implemented in the preparation of the isocyanate-terminated polyurethane prepolymer. In the application temperature range (typically around 90-100° C.), unreacted monomeric diisocyanates contained in the adhesive composition have a considerable vapor pressure and can be released in gaseous form. These diisocyanate vapors may be toxic, particularly irritant, such that safety measures have to be taken in industrial processes for implementing HMPURs. Aside from this problem of toxicity, HMPURs emit carbon dioxide during the crosslinking reaction. The formation of carbon dioxide in amorphous adhesives can lead to the formation of bubbles in the adhesive seal undergoing crosslinking.

Reactive hot-melt adhesive compositions comprising a polymer comprising at least one hydrolyzable alkoxysilane group have been developed as an alternative to HMPURs. Mention may thus be made of adhesive compositions based on modified silane polymers (MS polymers) having a high content of fillers, which are well known in the field of adhesives and which are used for the assembly by adhesive bonding of a wide variety of objects. MS polymers are polymers in which the main chain is a polyether, such as a poly(oxypropylene), and which comprise at least one, preferably two, silyl (or alkoxysilane) end groups.

The adhesive seals obtained from such adhesive compositions thus result from a crosslinking reaction of the polymer chains, via the alkoxysilane end group, in the presence of atmospheric humidity or humidity present at the surface of the substrates. These seals thus comprise a three-dimensional polymer network in which the polymer chains are connected by siloxane bonds and, due to their cohesion, make it possible to obtain a solid assembly. These seals are also advantageously temperature resistant.

Moreover, adhesive compositions based on alkoxysilane-terminated polyurethane (or polyether) are known and are described in particular by the three patent applications from Bostik: WO 09/106699, EP2336208 and WO 2020/128200. These adhesive compositions, which do not contain solvent or water, are implemented by coating onto a support layer at a temperature of between 5° and 150° C., with a view to preparing self-adhesive supports which are of use particularly for the manufacture of labels which can be readily attached, by virtue of the adhesive seal formed, to all sorts of substrates.

However, while implementing the latter adhesive compositions does not carry a risk associated with possible contact with diisocyanate monomers, its use as a semi-structural adhesive is faced with a major disadvantage associated with a particularly great risk of sagging.

Indeed, it may happen that either the first surface on which the bead of adhesive is initially deposited, or both substrates just after they have been brought into contact, are in a nonhorizontal position, in particular a vertical position, even though the crosslinking of the adhesive has not been completed. This results in exposing said bead, or said non-crosslinked adhesive seal bonding the two substrates in the assembly, to the force of gravity. This has the effect of a risk of deformation or creep or even sagging (also described as “slump”), under the action of the stress resulting from said force.

Such a change in shape of the bead (or of the non-crosslinked adhesive seal) is denoted in the remainder of the present text by the general term of “sagging”. It can thus result in a variation in the thickness of the adhesive during crosslinking between the two substrates, and thus an inhomogeneity, in particular a dimensional inhomogeneity, of the adhesive seal which firmly bonds the two substrates in the final assembly obtained after complete crosslinking. This inhomogeneity of the adhesive seal is particularly liable to adversely affect the mechanical properties thereof.

One aim of the present invention is thus to limit and/or do away with sagging (or creep) of adhesive compositions based on alkoxysilane-terminated polyurethane (or polyether), particularly those described in the abovementioned application by Bostik SA, WO 2020/128200.

Moreover, due to a long crosslinking time at ambient temperature, it is generally necessary to implement these compositions under hot conditions and in the presence of humidity, which may lead to needing to provide chambers with controlled humidity and temperature when it is desired to assemble substrates on an automated line.

Another aim of the present invention is thus to propose a crosslinkable adhesive composition based on a polymer comprising at least one hydrolyzable alkoxysilane group, which composition enables the assembly of two substrates by means of a crosslinking reaction which does not require relative humidity to be controlled and/or which is performed at a lower temperature, particularly at a temperature of less than 50° C., and even at ambient temperature.

Another aim of the present invention is to propose a crosslinkable adhesive composition based on a polymer comprising at least one hydrolyzable alkoxysilane group which crosslinks at ambient temperature and/or ambient humidity in a shorter time.

Another aim of the invention is for the adhesive seal formed by the crosslinking and which provides the assembly of the two substrates to have improved heat resistance.

Another aim of the invention is for said adhesive seal to have improved mechanical strength.

Another aim of the invention is for the thickness of said adhesive seal to be more uniform or homogeneous.

It has now been found that these aims can be completely or partially achieved by means of the adhesive composition, the use thereof as a semi-structural adhesive, and the process for assembling two substrates which are described below.

### DESCRIPTION OF THE INVENTION

### Crosslinkable Adhesive Composition:

Thus, firstly, the invention relates to a crosslinkable adhesive composition, characterized in that it comprises:
at least one polymer (A) comprising a hydrolyzable alkoxysilane group;
at least one tackifying resin (B);
at least one pyrogenic silica (C); and
at least one crosslinking catalyst (D).

It has now been found that the creeping (or sagging) of said adhesive composition is considerably reduced compared to the adhesive compositions based on alkoxysilane-terminated polyurethane (or polyether) which are particularly described in WO 2020/128200. It can thus advantageously lead to the deposition of said composition on a surface of a first substrate, even at a high weight per unit area, and particularly in the form of a bead, which leads, after crosslinking and bringing into contact with a second substrate, to an assembly in which the adhesive seal is homogeneous and has a uniform thickness.

Moreover, the crosslinking time of said crosslinkable composition is also greatly reduced at ambient temperature and humidity compared to the compositions of WO 2020/128200. This crosslinking time can advantageously be further shortened when the crosslinking is performed by means of a chamber with controlled temperature and humidity, which is particularly favorable to increasing the productivity of the assembly manufacture, for example when the said manufacture is performed on automotive construction assembly lines.

In addition, said adhesive composition can be applied in a temperature range extending from 30° C. to 130° C., preferably from 90° C. to 130° C.; in other words, at a lower application temperature than that of a hot-melt adhesive.

Furthermore, in addition to the abovementioned advantages for the implementation of the crosslinkable adhesive composition, due to the presence of the three-dimensional network formed by the crosslinking, the adhesive seal formed between the two substrates in the assembly offers greatly improved heat resistance compared to the non-reactive hot-melt adhesives known from the prior art. Finally, compared to the compositions of WO 2020/128200, said adhesive seal has improved properties of cohesion and adhesion to substrates. These properties are quantified by tensile breaking stress measurements on the adhesive seal alone and shear breaking stress measurements on the adhesive seal that joins together two substrates in an assembly.

### Polymer (A):

Within the meaning of the present invention, the term “polymer (A) comprising a hydrolyzable alkoxysilane group” is understood to mean a polymer which comprises at least one, and preferably at least two, hydrolyzable groups of formula (I):

—Si(R⁴)ₚ(OR⁵)₃₋ₚ (I)

wherein:
R⁴ represents a linear or branched alkyl radical comprising from 1 to 4 carbon atoms, with the possibility that, when there are several R⁴ radicals, these radicals are identical or different;
R⁵ represents a linear or branched alkyl radical comprising from 1 to 4 carbon atoms, with the possibility that, when there are several R⁵ radicals, these radicals are identical or different, with the possibility that two OR⁵ groups can participate in the same ring; and
p is an integer equal to 0, 1 or 2, preferably equal to 0 or 1.

The hydrolyzable alkoxysilane group is preferably positioned at the end of said polymer. However, a position in the middle of the chain is not excluded. The polymer (A) is not crosslinked before the application of the adhesive composition. The adhesive composition is applied under conditions which make possible its crosslinking.

The polymer (A) is thus a silyl-modified polymer which is generally provided in the form of a more or less viscous liquid. Preferably, the polymer (A) has a viscosity, in particular at 23° C., ranging from 10 to 200 Pa·s, preferably ranging from 20 to 175 Pa·s, said viscosity being measured, for example, according to a method of Brookfield type at 23° C. and 50% relative humidity (S28 spindle).

The polymer (A) preferably comprises two groups of formula (I) but it can also comprise from three to six groups of formula (I).

Preferably, the polymer(s) (A) have a number-average molecular weight (Mn) ranging from 500 to 50 000 g/mol, more preferably ranging from 700 to 20 000 g/mol. The number-average molecular weight (Mn) of the polymers can be calculated or measured by methods well known to those skilled in the art, for example by NMR and size exclusion chromatography using standards of polystyrene type.

According to one embodiment of the invention, the polymer (A) corresponds to one of the formulae (II), (III) or (IV):

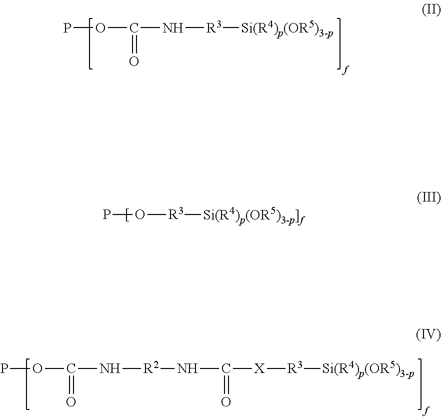

wherein:
R⁴, R⁵ and p have the same meaning as in formula (I) described above,
P represents a saturated or unsaturated, linear or branched, polymer radical optionally comprising one or more heteroatoms, such as oxygen, nitrogen, sulfur or silicon, and preferably having a number-average molecular weight (Mn) ranging from 100 g/mol to 48 600 g/mol, more particularly from 300 g/mol to 18 600 g/mol or else from 500 g/mol to 12 600 g/mol,
R¹ represents a divalent hydrocarbon radical comprising from 5 to 15 carbon atoms which can be aromatic or aliphatic, linear, branched or cyclic,
R³ represents a linear or branched divalent alkylene radical comprising from 1 to 6 carbon atoms, preferably from 1 to 3 carbon atoms,
X represents a divalent radical chosen from —NH—, —NR⁷— or —S—,
R⁷ represents a linear or branched alkyl radical comprising from 1 to 20 carbon atoms and which can also comprise one or more heteroatoms, and
f is an integer ranging from 1 to 6, preferably ranging from 2 to 5, preferably from 2 to 4, more preferably from 2 to 3.

Preferably, in formulae (II), (III) and/or (IV) above, P represents a polymer radical chosen, in a nonlimiting manner, from polyethers, polycarbonates, polyesters, polyolefins, polyacrylates, polyether polyurethanes, polyester polyurethanes, polyolefin polyurethanes, polyacrylate polyurethanes, polycarbonate polyurethanes, and block polyether/polyester polyurethanes.

For example, the document EP 2 468 783 describes silyl-modified polymers of formula (II) in which P represents a polymer radical having polyurethane/polyester/polyether blocks.

According to one embodiment, the silyl-modified polymers are chosen from silyl-modified polyurethanes, silyl-modified polyethers and mixtures thereof.

According to a particular embodiment, the silyl-modified polymer (A) corresponds to one of the formulae (II′), (III′) or (IV′):

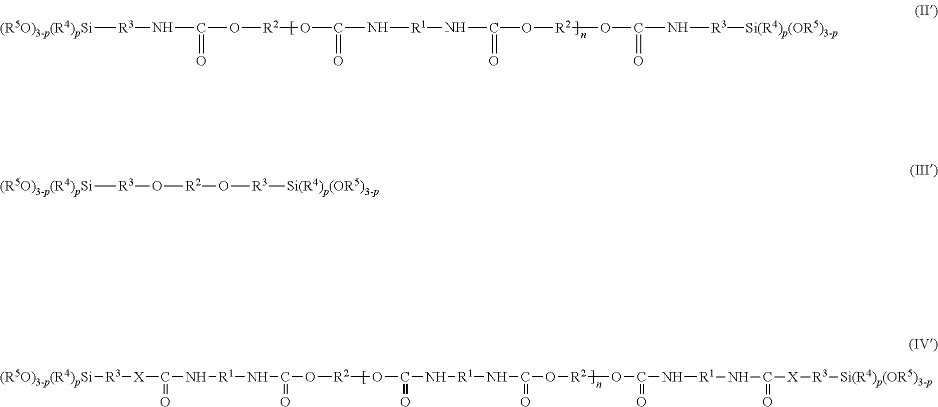

wherein:
R¹, R³, R⁴, R⁵, X, R⁷ and p have the same meaning as in formulae (II), (III) and (IV) described above,
R² represents a saturated or unsaturated, linear or branched, divalent hydrocarbon radical optionally comprising one or more heteroatoms, such as oxygen, nitrogen, sulfur or silicon, and preferably having a number-average molecular weight (Mn) ranging from 100 g/mol to 48 600 g/mol, more particularly from 300 g/mol to 18 600 g/mol or else from 500 g/mol to 12 600 g/mol, and
n is an integer greater than or equal to 0.

In the silyl-modified polymers of formulae (II′), (III′) and (IV′) defined above, when the R² radical comprises one or more heteroatoms, said heteroatom(s) are not present at the chain end. In other words, the free valencies of the divalent R² radical bonded to the neighboring oxygen atoms of the silyl-modified polymer each originate from a carbon atom. Thus, the main chain of the R² radical is terminated by a carbon atom at both ends, said carbon atom then having a free valency.

According to one embodiment, the silyl-modified polymers (A) are obtained from polyols chosen from polyether polyols, polyester polyols, polycarbonate polyols, polyacrylate polyols, polysiloxane polyols and polyolefin polyols and mixtures thereof, and more preferably from diols chosen from polyether diols, polyester diols, polycarbonate diols, polyacrylate diols, polysiloxane diols, polyolefin diols and mixtures thereof. In the case of the polymers of formulae (II′), (III′) and (IV′) described above, such diols can be represented by the formula HO—R²—OH where R² has the same meaning as in the formulae (II′), (III′) or (IV′).

For example, among the radicals of R² type which can be present in the formulae (II′), (III′) and (IV′), mention may be made of the following divalent radicals, the formulae of which below show the two free valencies:
derivative of a polypropylene glycol: P

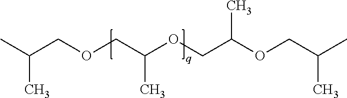

derivative of a polyester diol:

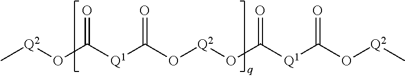

derivative of a polybutadiene diol:

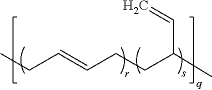

derivative of a polyacrylate diol:

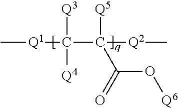

derivative of a polysiloxane diol:

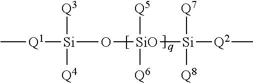

In the above formulae, the meaning of the radicals and indices is as follows:
q represents an integer such that the number-average molecular weight of the R² radical ranges from 100 g/mol to 48 600 g/mol, preferably from 300 g/mol to 18 600 g/mol, more preferably from 500 g/mol to 12 600 g/mol,
r and s represent zero or a non-zero integer such that the number-average molecular weight (Mn) of the R² radical ranges from 100 g/mol to 48 600 g/mol, preferably from 300 g/mol to 18 600 g/mol, more preferably from 500 g/mol to 12 600 g/mol, it being understood that the sum r+s is other than zero,
Q¹ represents a saturated or unsaturated, linear or branched aliphatic or aromatic divalent alkylene radical preferably having from 1 to 18 carbon atoms, more preferably from 1 to 8 carbon atoms,
Q² represents a linear or branched divalent alkylene radical preferably having from 2 to 36 carbon atoms, more preferably from 1 to 8 carbon atoms,
Q³, Q⁴, Q⁵, Q⁶, Q⁷ and Q⁸ represent, independently of one another, a hydrogen atom or an alkyl, alkenyl or aromatic radical preferably having from 1 to 12 carbon atoms, preferably from 2 to 12 carbon atoms, more preferably from 2 to 8 carbon atoms.

According to one embodiment of the composition according to the invention, the silyl-modified polymer (A) is such that the R² radical which appears in the formulae (II′), (III′) and (IV′) represents a polyether radical, preferably a poly(oxyalkylene) radical and more preferably still a radical derived from a polypropylene glycol corresponding to the formula indicated above.

According to one embodiment, R¹ is chosen from one of the following divalent radicals, the formulae of which below show the two free valencies:
a) the divalent radical derived from isophorone diisocyanate (IPDI):

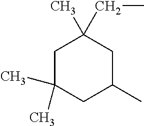

b) the divalent radical derived from dicyclohexylmethane diisocyanate (H12MDI)

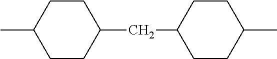

c) the divalent radical derived from toluene diisocyanate (TDI)

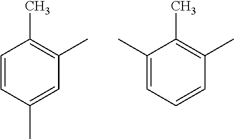

d) the divalent radicals derived from the 4,4′- and 2,4′-isomers of diphenylmethane diisocyanate (MDI)

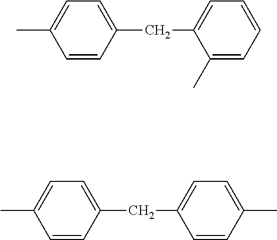

e) the divalent radical derived from hexamethylene diisocyanate (HDI) —(CH₂)₆—
f) the divalent radical derived from m-xylylene diisocyanate (m-XDI).

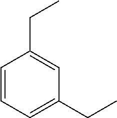

The polymers of formula (II) or (II′) can be obtained according to a process described in the documents EP 2 336 208 and WO 2009/106699. Those skilled in the art will know how to adapt the manufacturing process described in these two documents in the case of the use of different types of polyols. Mention may be made, among the polymers corresponding to the formula (II), of:
Geniosil® STP-E10 (available from Wacker): polyether comprising two groups (I) of dimethoxy type (n equal to 0, p equal to 1 and R⁴ and R⁵ represent a methyl group) having a number-average molecular weight of 8889 g/mol where R³ represents a methyl group;
Geniosil® STP-E30 (available from Wacker): with a number-average molecular weight of 14 493 g/mol, it is a polypropylene glycol with two end groups consisting of a dimethoxy(methyl)silylmethylcarbamate, i.e., in the formula (II′): n is equal to 0; p is equal to 1; R⁴ and R⁵ represent a methyl group and R³ represents a methyl group;
Desmoseal® S XP 2636 (available from Bayer): polyurethane comprising two groups (I) of trimethoxy type (n other than 0, p equal to 0 and R⁵ represents a methyl group) having a number-average molecular weight of 15 038 g/mol where R³ represents an n-propylene group.

The polymers of formula (III) or (III′) can be obtained by hydrosilylation of polyether diallyl ether according to a process described, for example, in the document EP 1 829 928. Mention may be made, among the polymers corresponding to the formula (III), of:
the polymer MS SAX® 350 (available from Kaneka) corresponding to a polyether comprising two groups (I) of dimethoxy type (p equal to 1 and R⁴ and R⁵ represent a methyl group) having a number-average molecular weight ranging from 14 000 to 16 000 g/mol;
the polymer MS SAX® 260 (available from Kaneka) corresponding to a polyether comprising two groups (I) of dimethoxy type (p equal to 1 and R⁴ and R⁵ represent a methyl group) having a number-average molecular weight of 16 000 to 18 000 g/mol where R³ represents an ethyl group;
the polymer MS S303H (available from Kaneka) corresponding to a polyether comprising two groups (I) of dimethoxy type (p is equal to 1 and R⁴ represents a methyl group) having a number-average molecular weight of approximately 22 000 g/mol.

The polymers of formula (IV) or (IV′) can, for example, be obtained by reaction of polyol(s) with one or more diisocyanate(s) followed by a reaction with aminosilanes or mercaptosilanes. A process for the preparation of polymers of formula (IV) or (IV′) is described in the document EP 2 583 988. Those skilled in the art will know how to adapt the manufacturing process described in this document in the case of the use of different types of polyols. Mention may be made, among the polymers corresponding to the formula (IV) or (IV′), of:
Spur+® 1050MM (available from Momentive): polyurethane comprising two groups (I) of trimethoxy type (n other than 0, p equal to 0 and R⁵ represents a methyl group) having a number-average molecular weight of 16 393 g/mol where R³ represents an n-propyl group;
Spur+® Y-19116 (available from Momentive): polyurethane comprising two groups (I) of trimethoxy type (n other than 0 and R⁵ represents a methyl group) having a number-average molecular weight ranging from 15 000 to 17 000 g/mol where R³ represents an n-propyl group.

According to a preferred embodiment of the invention, the adhesive composition comprises at least one silyl-modified polymer (A) of formula (II) and/or (II′) or at least one silyl-modified polymer of formula (III) and/or (III′).

According to a very particularly preferred embodiment of the invention, the polymer (A) is a silyl-modified polymer of formula (II′) in which n is equal to 0, R² is a divalent radical derived from a polyether, preferably from a poly(oxyalkylene) diol and more particularly still from a polypropylene glycol.

### Tackifying Resin (B):

The crosslinkable adhesive composition according to the invention also comprises at least one tackifying resin (B).

Said resin can be any resin compatible with the silyl-modified polymer(s) (A).

The term “compatible tackifying resin” is understood to mean a tackifying resin which, when it is mixed in proportions of 50%/50% (in particular by weight) with the polymer(s) (A), gives a substantially homogeneous mixture.

The resins (B) are advantageously chosen from:
(i) resins obtained by polymerization of terpene hydrocarbons and of phenols, in the presence of Friedel-Crafts catalysts;
(ii) resins obtained by a process comprising the polymerization of α-methylstyrene, it also being possible for said process to comprise a reaction with phenols;
(iii) rosins of natural origin or modified rosins (for instance the rosin extracted from pine gum, wood rosin extracted from tree roots and derivatives thereof which are hydrogenated, dimerized, polymerized or esterified with monoalcohols or polyols, such as glycerol or pentaerythritol);
(iv) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(v) terpene resins (which generally result from the polymerization of terpene hydrocarbons, for instance monoterpene (or pinene), in the presence of Friedel-Crafts catalysts);
(vi) copolymers based on natural terpenes (for instance styrene/terpene, α-methylstyrene/terpene and vinyltoluene/terpene); or else
(vii) acrylic resins having a viscosity at 100° C. of less than 100 Pa·s; and also from mixtures of these resins.

Such resins are commercially available and, among those of types (i), (ii), (iii) and (iv) defined above, mention may be made of the following products:
resins of type (i): Dertophene® 1510 available from DRT, having a number-average molecular weight (Mn) of approximately 870 Da; Dertophene® H150 available from the same company, with a number-average molecular weight (Mn) equal to approximately 630 Da; Sylvarez® TP 95 available from Arizona Chemical, having a number-average molecular weight (Mn) of approximately 1200 Da;
resins of type (ii): Cleartack® W100, available from Cray Valley, which is obtained by polymerization of α-methylstyrene without action of phenols, with a number-average molecular weight (Mn) of 900 Da; Sylvarez® 510, which is also available from Arizona Chemical, with a number-average molecular weight (Mn) of approximately 1740 Da, the process for the production of which also comprises the addition of phenols;
resins of type (iii): Sylvalite® RE 100, which is an ester of rosin and pentaerythritol available from Arizona Chemical and has a number-average molecular weight (Mn) of approximately 1700 Da;
resins of type (iv): Picco® AR100 available from Eastman and with a number-average molecular weight (Mn) of approximately 550 g/mol.

According to a preferred variant, use is made, as resin (B), of a resin chosen from those of type (i) or (iv).

### Pyrogenic Silica (C):

Pyrogenic silica (also called “fumed silica”) is provided in the form of very fine silica particles (of the order of a nanometer), with a very low apparent density and with a very high specific surface area. Pyrogenic silica can be obtained by pyrolysis, in the presence of hydrogen and oxygen, of silicon compounds, such as silicon tetrachloride, itself prepared from silicon and chlorine.

Pyrogenic silica is initially hydrophilic, due to the presence of silanol (Si—OH) groups at the surface of its constituent particles. It can be rendered hydrophobic by reaction of these silanol groups with various reactants, generally a silicone oil, such as polydimethylsiloxane (PDMS).

Preferably, the pyrogenic silica (C) is a hydrophobic pyrogenic silica.

According to one embodiment, the hydrophobic pyrogenic silica (C) is obtained by treatment of a pyrogenic silica with a polydimethylsiloxane.

According to one embodiment, the pyrogenic silica (C) has a BET specific surface area of at least 10 m²/g, preferably ranging from 50 to 400 m²/g, more preferably still from 80 to 290 m²/g. The BET specific surface area is measured, in a manner well known to those skilled in the art, by determination of an adsorption isotherm based on the Brunauer, Emmett and Teller (BET) method, for example according to the standard ISO 9277 of September 2010.

According to another embodiment, the pyrogenic silica (C) is obtained by a compaction treatment, for example from a roller compactor or from the process described by the patent EP 0 280 851. The apparent density is quantified by a measurement of the tapped apparent density, measured according to the standard ISO 787/11 of August 1983, which is generally within a range extending from 50 to 200 g/1.

Such pyrogenic silicas, in particular hydrophobic pyrogenic silicas, are commercially available, such as the products of the Aerosil® range from Evonik.

Mention may particularly be made, as an example of hydrophobic pyrogenic silica (C), of Aerosil® R202, the BET specific surface area of which is 100±20 m²/g, the tapped apparent density of which is approximately 60 g/1, and which is rendered hydrophobic by treatment with polydimethylsiloxane. The constituent particles of Aerosil® R202 have a size of approximately 16 nm.

### Crosslinking Catalyst (D):

The crosslinking catalyst (D) which can be used in the composition according to the invention can be any catalyst known to those skilled in the art for silanol condensation. Mention may be made, as examples of such catalysts, of organic titanium derivatives, such as titanium acetylacetonate (available commercially under the name Tyzor® AA75 from DuPont), organic aluminum derivatives, such as the aluminum chelate (available commercially under the name K-KAT® 5218 from King Industries), or amines, such as 1,8-diazobicyclo[5.4.0]undec-7-ene or DBU.

### Silsesquioxane Resin (E):

Besides the ingredients (A), (B), (C) and (D), the crosslinkable adhesive composition according to the invention can also comprise, optionally, a silsesquioxane resin (E).

According to a preferred variant of the invention, the crosslinkable adhesive composition according to the invention comprises at least one such silsesquioxane resin.

Silsesquioxane resins are organosilicon compounds which can adopt a polyhedral structure or a polymeric structure, with Si—O—Si bonds. They generally have the following general formula:

[RSiO_{3/2}]t

in which R, which may be identical or different in nature, represents an organic radical and t is an integer which may range from 6 to 12, t preferably being equal to 6, 8, 10 or 12.

According to one embodiment, the silsesquioxane (E) has a polyhedral structure (or POSS for “polyhedral oligomeric silsesquioxane”).

Preferably, the silsesquioxane (E) corresponds to the following general formula (V):

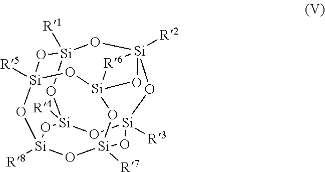

in which each of R′¹ to R′⁸ represents, independently of one another, a group chosen from:
a hydrogen atom,
a radical chosen from the group consisting of a linear or branched C1-C4 alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
an —OSiR′⁹R′¹⁰ group in which R′⁹ and R′¹⁰ each represents, independently of one another, a hydrogen atom or a radical chosen from the group consisting of linear or branched C1-C4 alkyls, linear or branched C1-C4 alkoxys, C2-C4 alkenyls, a phenyl, a C3-C6 allyl radical, a cyclic C3-C8 aliphatic radical and a C1-C4 acyl radical;

provided:
that at least one radical among the R′¹ to R′⁸ radicals is a C1-C4 alkoxy radical; and
that at least one radical among the R′¹ to R′⁸ radicals is a phenyl radical.

In particular, the silsesquioxane (E) is a dimethylmethoxyphenylsiloxane (CAS number=68957-04-0).

Silsesquioxanes are known compounds which are described in particular in the patent application WO 2008/107331. Some are also commercially available, such as the product from Dow sold under the name: Dow Corning® 3074 and Dow Corning® 3037 (CAS number=68957-04-0).

### Other Additives:

The crosslinkable adhesive composition according to the invention can also comprise one or more additives chosen from the group consisting of humidity absorbers, plasticizers, antioxidants, pigments, dyes, adhesion promoters, UV stabilizers, flame-retardant additives and also fillers, such as carbonate-based fillers, for example of calcium carbonate type.

The humidity absorber (or desiccant) can, for example, be chosen from nonpolymeric hydrolyzable alkoxysilane derivatives, with a molecular weight of less than 500 g/mol, preferably chosen from trimethoxysilane and triethoxysilane derivatives. Such an agent can typically extend the shelf life of the composition during storage and transportation before it is used. Mention may be made, for example, of 7-methacryloyloxypropyltrimethoxysilane (for example available under the trade name Silquest® A-174 from Momentive), methacryloyloxymethyltrimethoxysilane (for example available under the name Geniosil® XL33 from Wacker), vinyltrimethoxysilane, isooctyltrimethoxysilane or phenyltrimethoxysilane.

When it is present, the humidity absorber can represent, for example, from 0.1% to 3% by weight or from 1% to 2% by weight relative to the total weight of the composition according to the invention.

The composition according to the invention can also comprise a plasticizer.

Use may be made, as examples of plasticizers which can be used, of any plasticizer customarily used in the field of adhesives, for instance phthalates, benzoates, trimethylolpropane esters, trimethylolethane esters, trimethylolmethane esters, glycerol esters, pentaerythritol esters, naphthenic mineral oils, adipates, cyclohexanedicarboxylates, liquid paraffins, natural oils (optionally epoxidized), polypropylenes, polybutylenes, hydrogenated polyisoprenes and mixtures thereof.

Mention may be made, among the phthalates, for example, of diisononyl phthalate, diisobutyl phthalate, dioctyl phthalate, dicyclohexyl phthalate, diisooctyl phthalate, diisododecyl phthalate, dibenzyl phthalate or butyl benzyl phthalate.

Mention may be made, among the benzoates, for example, of: neopentyl glycol dibenzoate (for example available under the name Uniplex® 512 from Lanxess), dipropylene glycol dibenzoate (for example available under the name Benzoflex® 9-88SG from Eastman), a mixture of diethylene glycol dibenzoate and of dipropylene glycol dibenzoate (for example available under the name K-Flex® 850 S from Kalama Chemical) or else a mixture of diethylene glycol dibenzoate, of dipropylene glycol dibenzoate and of triethylene glycol dibenzoate (for example available under the name Benzoflex® 2088 from Eastman).

Mention may be made, among the pentaerythritol esters, for example, of pentaerythrityl tetravalerate (for example available under the name Pevalen™ from Perstorp).

Mention may be made, among the cyclohexanedicarboxylates, for example, of diisononyl 1,2-cyclohexanedicarboxylate (for example available under the name Hexamoll Dinch® from BASF) and 1,4-bis(2-ethylhexyl) 1,4-cyclohexanedicarboxylate (for example available under the name DEHCH from Connect Chemicals).

The total content of plasticizer(s) in the composition according to the invention can range from 0% to 30% by weight, preferably from 1% to 30% by weight, indeed even, for example, from 1% to 15% by weight, relative to the total weight of said composition.

The composition according to the invention can also comprise an antioxidant (also denoted by the term UV stabilizer).

Antioxidants are compounds which can be introduced in order to protect the composition from degradation resulting from a reaction with oxygen which is liable to be formed by the action of heat or of light. These compounds can include primary antioxidants which scavenge free radicals. The primary antioxidants can be used alone or in combination with other secondary antioxidants or UV stabilizers.

Mention may be made, for example, of Irganox® 1010, Irganox® B561, Irganox® 245, Irganox® 1076 or Irgafos® 168, which are sold by BASF.

An amount of antioxidant ranging from 0.1% to 3%, preferably from 1% to 3%, by weight, on the basis of the total weight of the composition according to the invention, is generally used.

According to one embodiment, the crosslinkable adhesive composition according to the invention comprises:
from 3% to 90% by weight, preferably from 5% to 80% by weight, preferentially from 10% to 70% by weight, in particular from 20% to 60% by weight, advantageously from 36% to 56% by weight, of at least one polymer (A) comprising a hydrolyzable alkoxysilane group;
from 8% to 80% by weight, in particular from 15% to 80% by weight, preferably from 20% to 70% by weight, preferentially from 25% to 70% by weight, especially from 30% to 60% by weight, advantageously from 40% to 60% by weight, of at least one tackifying resin (B);
from 1% to 10% by weight, preferably from 2% to 8% by weight, advantageously from 2% to 6% by weight, of the pyrogenic silica (C); and
from 0.01% to 10% by weight, preferably from 0.01% to 5% by weight, preferentially from 0.05% to 4% by weight, advantageously from 0.1% to 3% by weight, in particular from 0.5% to 2% by weight, of crosslinking catalyst (D);
these percentages by weight being indicated on the basis of the total weight of said composition.

When, according to preferred alternative form of the invention, the crosslinkable adhesive composition additionally comprises a silsesquioxane resin (E), the amount of the latter can vary from 0.1% to 20% by weight, preferably from 1% to 20% by weight, preferentially from 2% to 15% by weight, advantageously from 3% to 12% by weight, on the basis of the total weight of said composition.

The crosslinkable adhesive composition according to the invention can be prepared by a process which comprises:
a step of mixing, with the exclusion of air, preferably under an inert atmosphere, the polymer (A), the tackifying resin (B) and, if appropriate, the other optional additives, to form a part (PA); then
a step of mixing the crosslinking catalyst (D) with, when it is present, the silsesquioxane resin (E), to form a part (PB); then
a step of incorporating the pyrogenic silica (C) in the part (PA), at a temperature of between 50° C. and 180° C., preferably between 100° C. and 150° C., until a homogeneous mixture (PC) is obtained; and finally
a step of mixing (PC) with (PB).

### Use of the Crosslinkable Adhesive Composition:

The present invention also relates to the use of the crosslinkable adhesive composition as defined above for the semi-structural assembly of two substrates.

Semi-structural assembly means an assembly of two substrates in which the adhesive seal is able to withstand shear stresses within a range extending from 2 to 8 MPa.

The substrates in question are highly varied and are chosen in particular from:
metals (such as aluminum or steel) and composites, optionally coated with paint (such as those used in the automotive sector);
cardboard, textiles, leather, glass;
thermoplastic polymers, such as:
   polyolefins (for example polyethylene or polypropylene) which have optionally received a preliminary surface treatment such as a fixing primer, a plasma treatment or a corona treatment;
   acrylonitrile butadiene styrene (ABS);
   styrene-acrylonitrile (SAN);
   polyvinyl chloride (PVC);
   polycarbonate;
   poly(methyl methacrylate) (PMMA); or else
   polyesters.

According to a preferred variant, the crosslinkable adhesive composition is used in the fields of electronics, construction, the manufacture of means of transport, preferably in the automotive, rail, aerospace and shipbuilding industries. It can also be used for assembling two substrates outside, due to its resistance to variable climate conditions.

### Assembly Process:

The present invention also relates to a process for assembling two substrates, comprising:
a step (i) of melting the adhesive composition as defined above, by heating to a temperature of between 3° and 130° C., then
a step (ii) of depositing said composition on a surface of a first substrate, then
a step (iii) comprising:
   a step (iii1) of crosslinking said composition by heating at a temperature ranging from 15° C. to 200° C.; and
   a step (iii2) of bringing said surface into contact with a surface of a second substrate.

The first and second substrate can be different or of the same chemical nature, and are as defined above.

Step (i) of melting is advantageously performed in a temperature range which is lower than that for hot-melt adhesives, which is generally from 150° C. to 210° C.

According to a first particularly preferred embodiment of step (ii), the composition is deposited in the form of a bead. The diameter of such a bead is generally within a range extending from 0.1 mm to 2 cm. Such a bead can be obtained by hot extrusion of the adhesive through a connected die or else from a cartridge held by an operator, or else from a reservoir in the case of robotic application on an assembly line. Such an application is particularly advantageous in the industrial fields mentioned above for the use of the composition. The reduction, or even elimination, of sagging from the crosslinkable adhesive composition according to the invention advantageously makes it possible to apply said composition in said bead form on substrates which are inclined relative to a horizontal plane, and to form, after the crosslinking step (iii1), an adhesive seal which advantageously has uniform thickness and uniform mechanical properties.

According to a second embodiment of step (ii), the composition is deposited in the form of a layer having a thickness of between 0.1 mm and 2 cm, preferably between 1 mm and 10 mm. Such a layer can be obtained by spraying, by extrusion (for example by means of a die, such as a slotted nozzle), by coating (for example by means of rollers or doctor blades).

Step (iii1) of crosslinking the adhesive composition according to the invention is performed by heating said composition at a temperature ranging from 15° C. to 200° C.

According to a first variant of this embodiment, said step (iii1) is performed at a temperature ranging from 15° C. to 45° C., preferably at ambient temperature, in particular between 18° C. and 25° C., particularly at 23° C., and in the presence of ambient humidity, in particular at an absolute humidity of 20 to 60 g of water per m³ of air, preferably from 40 to 60 g/m³. Such crosslinking conditions are particularly advantageous because they make it possible to perform an industrial crosslinking process which does not require the presence of an oven. They also make it possible to choose the second substrate from heat-sensitive substrates such as polyethylene, polypropylene, foams or textiles.

According to a second variant of this embodiment, said step (iii1) is performed at a temperature ranging from 90° C. to 160° C., more preferably from 120° C. to 140° C., and in the presence of absolute humidity ranging from 10 to 200 g of water per m³ of gas (particularly air), preferably from 20 to 60 g/m³, even more preferentially from 40 to 50 g/m³. Such crosslinking conditions are for example obtained by means of furnaces (or chambers) placed on automated assembly lines.

This crosslinking step (iii1) has in particular the effect of creating—between the polymer chains having hydrolyzable alkoxysilane end groups of the adhesive composition and under the action of atmospheric humidity—bonds of siloxane type which result in the formation of a three-dimensional polymeric network.

In the assembly process according to the invention, steps (i), (ii) and (iii) are performed sequentially.

Regarding steps (iii1) and (iii2) contained within step (iii), they can be performed in any order and even simultaneously.

Thus, according to a first embodiment of step (iii), step (iii1) of crosslinking the composition is performed until the reaction is complete. It is then followed by step (iii2) of bringing into contact (or “affixing”) the second substrate. This embodiment is particularly advantageous in the case where the second substrate is chosen from heat-sensitive substrates such as those mentioned above.

According to a second embodiment of step (iii), step (iii2) of affixing is performed simultaneously to step (iii1) of crosslinking, even though the crosslinking reaction is not yet complete. In this case, said crosslinking reaction is continued and completed after the second substrate is affixed.

According to a third embodiment of step (iii), step (iii2) of affixing the second substrate is performed first, then is followed by step (iii1) of crosslinking the adhesive composition contained between the two surfaces of the substrates thus brought into contact.

According to a fourth embodiment of step (iii), step (iii1) of crosslinking the composition is performed partially before step (iii2) of bringing into contact (or “affixing”) the second substrate. In this case, said crosslinking reaction (iii1) is continued and completed after the second substrate is affixed.

Finally, the present invention relates to an assembly process comprising at least two substrates bonded by the adhesive composition as defined above, in the crosslinked state.

The invention is now described in the following implementation examples, which are given purely by way of illustration and should not be interpreted as limiting the scope thereof.

### Example A (Comparative According to WO 2020/128200)

Heat-crosslinkable adhesive composition based on Geniosil® STP-E30

### A1. Preparation of the Composition:

The composition in table 1 is prepared by first of all introducing the tackifying resin Picco® AR100 into a glass reactor under vacuum and heated to approximately 160° C. Then, once the resin has fully melted, the Geniosil® STP-E30 is added.

The mixture is stirred under vacuum for 15 minutes, then cooled to 70° C. The catalyst (K-KAT® 5218) and the silsesquioxane Dow Corning® 3074 are then introduced. The mixture is kept under vacuum and with stirring for a further 10 minutes.

### A2. Measurement of Sagging:

The composition thus prepared is deposited on a card-based substrate by means of a hand gun in the form of a bead having a diameter of 5 mm, at a temperature of 120° C.

The bead is crosslinked in the vertical position at a temperature of 140° C. and in the presence of an absolute humidity of 50 g/m³ for 1 minute.

The distance over which the bead has sagged is then measured, between its initial position and its furthest final position.

The result obtained is given in table 1.

### A3. Measurement of the Crosslinking Time at Ambient Temperature:

The composition prepared in A1 is applied at 120° C. so as to fill a mold corresponding to a test specimen of H2 type, as defined by the standard NF T46-002, the thickness of which is 4 mm and the central part of which has a rectangular section of 4×2 mm over a length of 25 mm.

Said mold is left at ambient temperature (approximately 23° C.) and the behavior of the composition is observed.

The time necessary for complete crosslinking is given in table 1.

### A4. Measurement of the Breaking Stress and of the Elongation at Break of the Adhesive Seal by a Tensile Test:

The principle of the measurement consists in drawing, in a tensile testing device, the movable jaw of which moves at a constant rate equal to 100 mm/minute, a test specimen of H2 type as defined above consisting of the crosslinked adhesive composition, and in recording, at the moment when the test specimen breaks, the stress applied (in MPa) and also the elongation of the test specimen (in %).

The results of the measurements obtained are given in table 1.

### A5. Measurement of the Breaking Stress of the Adhesive Seal on a Polypropylene (PP) Support Using Shear Testing:

Use is made of two parallelepipedal PP test specimens 100 mm long, 25 mm wide and 2.5 mm thick.

The adhesive composition, packaged in a cartridge, is applied at 120° C. in the form of a bead having a diameter of approximately 5 mm, which is deposited on a coverage region located at the end of a first test specimen 25 mm wide and 12.5 mm long.

One end of the second test specimen is then pressed onto said region such that the two test specimens overlap one another, their two free ends are located symmetrically with respect to the overlap region, and, using a wedge system and removing the excess adhesive by means of a spatula, the adhesive layer resulting from squeezing the bead in the overlap region is 800 μm thick.

The adhesive composition is left to crosslink in the assembly thus obtained for 24 hours under standard conditions (23° C. and in the presence of an absolute humidity of 10 g of water per m³).

The assembly is then subjected to a shear test using a universal testing machine operating at a rate of 10 mm/minute until the two test specimens separate and the assembly fails.

The test is repeated 3 times and the mean of the shear stresses corresponding to failure of the assembly is reported in table 1.

### A6. Test of Temperature Resistance of the Adhesive Seal:

A6.1: Prior Preparation of a PET Support Layer Coated with the Crosslinked Composition, at a Weight Per Unit Area Equal to 60 g/m²:

A rectangular sheet of polyethylene terephthalate (PET) with a thickness of 50 μm and dimensions of 20 cm by 40 cm is used as support layer.

The composition obtained in point A1 is preheated to a temperature close to 100° C. and is introduced into a cartridge, from where a bead is extruded which is deposited close to the edge of the sheet parallel to its width.

The composition included in this bead is then spread over the whole surface of the sheet, so as to obtain a uniform layer of substantially constant thickness. A film spreader (also known as a film applicator) is used to do this, and is moved from one edge of the sheet to the opposite edge. A layer of composition corresponding to a weight per unit area of 60 g/m² is thus deposited, representing an approximate thickness of the order of 60 μm.

The PET sheet thus coated is then placed in an oven at 120° C. and under a humid atmosphere (50 g/m³ absolute humidity) for 5 minutes for crosslinking of the composition and then laminated on a nonstick protective layer (or “release liner”) consisting of a sheet of silicone film which is rectangular and has the same dimensions.

The triple layer obtained is subjected to the test described below.

### A6.2: Static Shear Strength Time of the Adhesive Seal at 125° C.:

The heat resistance of the adhesive seal consisting of the crosslinked adhesive composition is evaluated using a test which determines the time for which said adhesive seal resists static shearing at 125° C. For this test, reference is made to the FINAT No. 8 method. The principle is as follows:

A test specimen in the form of a rectangular strip (25 mm×75 mm) is cut out from the triple layer obtained previously and is stored at ambient temperature (23° C., 50% humidity) for 24 hours.

After removing the whole of the protective nonstick layer, a square portion with a side length of 25 mm located at the end of the adhesive strip is attached to a glass plate.

The test plate thus obtained is introduced, by means of an appropriate support, in a substantially vertical position into an oven at 125° C., the non-adhesively bonded part of the strip with a length of 50 mm being located below the plate. After thermal equilibration, the portion of the strip which has remained free is connected to a 1 kg weight, the entire device always remaining in the oven at 125° C. for the duration of the test.

Under the effect of this weight, the adhesive seal attaching the strip to the plate is subjected to a shear stress. For more effective monitoring of this stress, the test plate is in fact placed so as to form an angle of 2° with respect to the vertical.

The time at the end of which the strip detaches from the plate following the failure of the adhesive seal under the effect of this stress is recorded.

The result, expressed in hours, is shown in table 1.

### Examples B and C: Comparative Adhesive Compositions Based on Geniosil® STP-E30

The preparation of the composition of example A as shown in point A1 is repeated, except that:
for example B: silsesquioxane is not introduced,
for example C: silsesquioxane is not introduced and, after addition of the catalyst and then stirring for 10 minutes, Aerosil® R202 is introduced and stirring is again carried out for approximately 10 minutes.

The measurement of sagging, of the crosslinking time at ambient temperature, and also the tensile tests and shear tests, as shown in points A2, A3, A4, A5 and A6, are repeated. The results given in table 1 are obtained.

### Examples 1 and 2 According to the Invention: Adhesive Compositions Crosslinkable at Ambient Temperature Based on Geniosil® STP-E30

The preparation of the composition of example A as shown in point A1 is repeated, except that, after addition of the catalyst and of the silsesquioxane and then stirring for 10 minutes, Aerosil® R202 is introduced and stirring is again carried out for approximately 10 minutes.

The measurement of sagging, of the crosslinking time at ambient temperature, and also the tensile tests and shear tests, as shown in points A2, A3, A4 and A5, are repeated. The results given in table 1 are obtained.

It is observed that:
the sagging of the composition of examples 1 and 2 is greatly reduced compared to example B. In addition, the sagging of the composition of example 2 is eliminated, demonstrating the superior effect of the combination of the silsesquioxane resin (E) with the pyrogenic silica (C), compared to the effect of the silsesquioxane resin (E) (example A) or the pyrogenic silica (C) (example C);
for example 2: the crosslinking time at ambient temperature is, compared to example B, considerably decreased (by more than a factor of 2);
for example 2: the tensile breaking stress on the adhesive seal is markedly increased compared to example B. However, the separate addition of silsesquioxane resin (E) or of pyrogenic silica (C) results in a decrease in the breaking stress (examples A and C). The increase in the tensile breaking stress observed for the addition of a combination of silsesquioxane resin (E) and of pyrogenic silica (C) is thus completely unexpected and demonstrates a synergy between these ingredients;
the cohesion of the adhesive seal of examples 1 and 2 in the assembly of PP substrates, evaluated using the shear breaking stress, is, unlike examples A and B, of an order of magnitude representative of a semi-structural adhesive. By way of reference, the corresponding value determined for the polyamide hot-melt adhesive sold by Bostik SA as a semi-structural adhesive under the name HM4229 is 6 MPa. It should be noted that the addition of a silsesquioxane resin (E) without a pyrogenic silica (C) (example A) has no effect on the breaking stress compared to example B. It would therefore be expected that the addition of a combination of silsesquioxane resin (E) and of pyrogenic silica (C) would lead to the same breaking stress as a composition comprising pyrogenic silica (C) without silsesquioxane resin (E) (example C). However, the breaking stress is further increased, demonstrating a synergistic effect between these ingredients.

The preparation of the self-adhesive PET support layer, as shown in point A6.1, is also repeated, except that the coated PET sheet is left under ambient temperature and humidity conditions (approximately 23° C. and 10 g/m³ absolute humidity) for 7 h for crosslinking, before being laminated on the protective nonstick layer. The triple layer obtained is subsequently subjected to the test described in point A6.2, which leads to the results given in table 1.

The results show that the addition of silsesquioxane resin (E) (example A) leads to an improvement in the shear strength at 125° C. (comparison with example B), whereas the addition of pyrogenic silica (C) (example C) has virtually no effect on the shear strength at 125° C. On the other hand, shear strength values at 125° C. for the adhesive seal of examples 1 and 2 are observed which demonstrate a temperature cohesion far superior to that of examples A, B and C. Thus, the addition of a combination of silsesquioxane resin (E) and of pyrogenic silica (C) makes it possible to improve, surprisingly, the shear strength at 125° C., with these ingredients acting in synergy. In addition, such cohesion can advantageously be obtained at ambient temperature and humidity, without using an oven (or furnace) as for examples A, B and C.

TABLE 1

| | | Content in % weight/weight | | | | |
|---|---|---|---|---|---|---|
| Ingredient | | Example A | Example B | Example C | Example 1 | Example 2 |
| (A) | Geniosil ® STP-E30 | 42.4 | 44.7 | 42.4 | 40.84 | 40.19 |
| (B) | Picco ® AR100 | 51.6 | 54.3 | 51.6 | 49.71 | 48.94 |
| (C) | Aerosil ® R202 | — | — | 5 | 3.5 | 5.0 |
| (D) | K-KAT ® 5218 | 1 | 1 | 1 | 0.98 | 0.98 |
| (E) | Dow Corning ® 3074 | 5 | — | — | 4.97 | 4.89 |

| | | | | | |
|---|---|---|---|---|---|
| Sagging (cm) | 5 | 15 | 1 | 1 | 0 |
| Crosslinking time at ambient | 24 | 18 | 5.67 | NA | 7 |
| temperature (hours) | | | | | |
| Tensile test of the adhesive seal: | | | | | |
| breaking stress (MPa) | 0.16 | 0.28 | 0.11 | ND | 0.39 |
| elongation at break (%) | 326 | ND | ND | ND | 300 |
| Shear test of the adhesive seal: | | | | | |
| breaking stress (MPa) | * | * | 3 | 4 | 5 |
| Shear strength time of the | 24 | 16 | 15.5 | 70 | 40 |
| adhesive seal at 125° C. (hours) | | | | | |

ND = Not Determined
*: below sensitivity threshold of the force sensor

1. A crosslinkable adhesive composition, characterized in that it comprises:
at least one polymer (A) comprising a hydrolyzable alkoxysilane group;
at least one tackifying resin (B);
at least one pyrogenic silica (C);
at least one crosslinking catalyst (D); and
a silsesquioxane resin (E).

2. The adhesive composition as claimed in claim 1, characterized in that the polymer (A) comprises at least one, hydrolyzable group of formula (I):
—Si(R⁴)ₚ(OR⁵)₃₋ₚ (I)
wherein:
R⁴ represents a linear or branched alkyl radical comprising from 1 to 4 carbon atoms, with the possibility that, when there are several R⁴ radicals, these radicals are identical or different;
R⁵ represents a linear or branched alkyl radical comprising from 1 to 4 carbon atoms, with the possibility that, when there are several R⁵ radicals, these radicals are identical or different, with the possibility that two OR⁵ groups can participate in the same ring; and
p is an integer equal to 0, 1 or 2.

3. The adhesive composition as claimed in claim 1, characterized in that the pyrogenic silica (C) is hydrophobic.

4. The adhesive composition as claimed in claim 3, characterized in that the hydrophobic pyrogenic silica (C) is obtained by treatment of a pyrogenic silica with a polydimethylsiloxane.

5. The adhesive composition as claimed in claim 1, characterized in that the pyrogenic silica (C) has a BET specific surface area of at least 10 m²/g.

6. The adhesive composition as claimed in claim 1, characterized in that the silsesquioxane resin (E) corresponds to the following general formula (V): 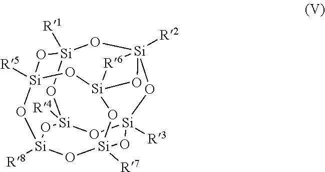
in which each of R′¹ to R′⁸ represents, independently of one another, a group chosen from:
a hydrogen atom,
a radical chosen from the group consisting of a linear or branched C1-C4 alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
an —OSiR′⁹R′¹⁰ group in which R′⁹ and R′¹⁰ each represents, independently of one another, a hydrogen atom or a radical chosen from the group consisting of linear or branched C1-C4 alkyls, linear or branched C1-C4 alkoxys, C2-C4 alkenyls, a phenyl, a C3-C6 allyl radical, a cyclic C3-C8 aliphatic radical and a C1-C4 acyl radical;
provided:
that at least one radical among the R′¹ to R′⁸ radicals is a C1-C4 alkoxy radical; and
that at least one radical among the R′¹ to R′⁸ radicals is a phenyl radical.

7. The adhesive composition as claimed in claim 1, characterized in that it comprises:
from 3% to 90% by weight of at least one polymer (A);
from 8% to 80% by weight of at least one tackifying resin (B);
from 1% to 10% by weight of the pyrogenic silica (C);
from 0.01% to 10% by weight of crosslinking catalyst (D); and
from 0.1% to 20% by weight of silsesquioxane resin (E);
these percentages by weight being indicated on the basis of the total weight of said composition.

8. A semi-structural assembly of two substrates comprising the crosslinkable adhesive composition of claim 1.

9. The semi-structural assembly of two substrates as claimed in claim 8 in the fields of electronics, construction, and/or the manufacture of means of transport.

10. A process for assembling two substrates, comprising:
a step (i) of melting the adhesive composition as defined in claim 1, by heating at a temperature of between 3° and 130° C., then
a step (ii) of depositing said adhesive composition on a surface of a first substrate, then
a step (iii) comprising:
a step (iii1) of crosslinking said adhesive composition by heating at a temperature ranging from 15° C. to 200° C.; and
a step (iii2) of bringing said surface of a first substrate into contact with a surface of a second substrate.

11. The process as claimed in claim 10, characterized in that, in step (ii), the composition is deposited on the surface of the first substrate in the form of a bead.

12. The process as claimed in claim 10, characterized in that, in step (ii), the composition is deposited on the surface of the first substrate in the form of a layer having a thickness of between 0.1 mm and 2 cm.

13. The process as claimed in claim 10, characterized in that the crosslinking step (iii1) is performed at a temperature ranging from 15° C. to 45° C., and in the presence of ambient humidity.

14. The process as claimed in claim 10, characterized in that the crosslinking step (iii1) is performed at a temperature ranging from 90° C. to 160° C. and in the presence of an absolute humidity ranging from 10 to 200 g of water per m³ of gas.

15. An assembled product comprising at least two substrates bonded by the adhesive composition as defined in claim 1.
